(19) United States
(12) Patent Application Publication
(10) Pub. No.: US 2014/0268694 A1
(43) Pub. Date: Sep. 18, 2014

(54) COMBINED FLOATABLE LUMINARY AND CONTAINER

(71) Applicant: Eppco Enterprises Inc., Cleveland, OH (US)

(72) Inventors: Michael Epstein, Cleveland, OH (US); David Stang, Cleveland, OH (US)

(21) Appl. No.: 14/204,143

(22) Filed: Mar. 11, 2014

Related U.S. Application Data
(60) Provisional application No. 61/777,074, filed on Mar. 12, 2013.

(51) Int. Cl. F21S 13/00

(52) U.S. Cl. CPC F21S 13/00
USPC 362/154

(57) ABSTRACT

A plastic at least partially transparent container holds water with a luminary floating on the water. The water closes a circuit causing the luminary to light up.

The present application claims benefit from provisional application 61/777,074 and incorporates same herein by reference.

The present invention relates to a decorative product comprising a luminary and a decorative container adapted to hold water and the luminary which floats in the water within the container.

Products for permitting lighted candles to float on water are known. Attention is invited to the following U.S. patents, the contents of which are incorporated herein: Kellmann 2008/0175006 (see also 2008/00175005); Reichlin, Jr. 2006/0227541; Boulachanis U.S. Pat. No. 7,214,054 (see also U.S. Pat. No. 7,090,369 for Jordan); Weiss U.S. Pat. No. 6,971,535; Cutts U.S. Pat. No. 5,980,061 (see also U.S. Pat. No. 5,697,694); Jurkofsky U.S. Pat. No. 5,434,393; Collaso U.S. Pat. No. 5,244,136; Cox U.S. Pat. No. 4,898,477 (see also U.S. Pat. No. 5,184,896 to Hammond); Burke II U.S. Pat. No. 4,875,508; and Eisenberger U.S. Pat. No. 2,618,409

The present invention comprises two elements, namely a luminary 10 and an expandable container 12. When the expandable container 12 is opened or expanded to form a stable base at its bottom, and then partially filled with water, the luminary 10 is then placed into the container and on the water, whereby the luminary 10 floats on the water, and a circuit is closed which results in the luminary lighting up.

An embodiment of the present invention and features thereof will become apparent from the attached drawings made a part hereof, and from the following detailed description of such embodiment.

FIG. 1 shows a luminary in plan view and a container in side view before opening of the container.

FIG. 2 shows a plan view of the container, and a perspective view of the luminary.

FIG. 3 is a perspective view of the luminary together with the instruction sheet for use thereof.

FIG. 4 is a view similar to FIG. 3 but showing a bottom view of the luminary.

FIGS. 5 and 6 show front and rear views of a package containing the expandable container (four such expandable containers in this embodiment) and the luminaries which go therein, FIG. 6 containing an illustration of use of the present invention.

FIG. 7 is a top plan view of the container opened for insertion therein of water and a luminary.

FIG. 8 is a bottom perspective view of the container in an inverted position.

The luminary in the illustrated embodiment is identified by the reference numeral or character 10, and the preferably at least partially transparent container by the reference numeral or character 12.

The luminary 10 is formed of a water imperious plastic material shell and is made sufficiently buoyant so that it floats on water. Noting particularly FIG. 3, the luminary 10 comprises a tip portion 14 to light up, desirably an LED and preferably in the shape of a flame, and a base 16. The base contains a power source, desirably a battery, and circuitry which can be simple and well known, to cause the tip 14 to light. With reference to FIG. 4, the circuitry comprises two electrodes 18; when the luminary 10 is placed in water, the two electrodes 18 contact the water and cause the circuit to close and thus cause the light in the tip portion 14 to light up. The luminary 10 may be made hollow to enhance its ability to float and/or be made of a plastic material, e.g. polyethylene, which has a density less than that of water.

Noting especially FIGS. 7 and 8, the container 10, capable of holding water without leaking, comprises a pair of flexible plastic side walls 20 and 22, and a bottom gusset panel or wall 24 which forms an upwardly facing concave bottom wall (convex as shown in FIG. 8 from the bottom) when the container is opened. The side walls 20 and 22 are heat sealed or adhesively adhered along the edges 26, and the side walls are also sealed along areas 28 (see FIG. 2).

In use, the side walls 20 and 22 of the container 10 are pulled apart opening the bottom wall 24 to its internal concave shape. Water is then put in the container 12 to a desired level, and the luminary 10 is then floated on the water. As soon as the electrodes 18 both contact the water, the circuit is closed and the luminary lights up, preferably in a flickering mode as controlled by the circuit within the luminary 10, whereby the light of the luminary can be seen through the at least partially transparent walls 20 and 22 and through the open top of the container 12.

The walls 20 and 22 of the container 12 may be provided with patterns which in turn may be opaque or translucent, thus further enhancing the visual effects provided by the lighted and optionally flickering luminary 10.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. The combination of an at least partially translucent or transparent container capable of holding water, and a luminary capable of floating in water within the container, wherein the water in the container closes a circuit in the luminary causing the luminary to light.

2. The combination of claim 1 wherein the circuit causes the luminary to flicker.

3. The combination of claim 1 wherein the container is expandable from a flat condition to an open condition for acceptance of water.

4. The combination of claim 3 wherein the container in open condition has an internally concave bottom wall.

5. The combination of claim 2 wherein the container is expandable from a flat condition to an open condition for acceptance of water.

6. The combination of a claim 5 wherein the container in open condition has an internally concave bottom wall.
